(19) United States
(12) Patent Application Publication
(10) Pub. No.: US 2001/0016450 A1
(43) Pub. Date: Aug. 23, 2001

(54) Protective enclosure for multicore electric cable connections

(75) Inventor: Giorgio Gutris, Milano (IT)

Correspondence Address: GREER, BURNS & CRAIN, LTD., 25th Floor, 300 S. Wacker Drive, CHICAGO, IL, 60606, US

(73) Assignee: European Electric Motors Design and

(21) Appl. No.: 09/788,205

(22) Filed: Feb. 16, 2001

(30) Foreign Application Priority Data
Feb. 17, 2000 (IT) MI2000A000274

(51) Int. Cl. H01R 13/58

(52) U.S. Cl. 439/467

(57) ABSTRACT

A protective enclosure for the connections of a multicore electric cable and/or of the unipolar leads carrying current to a connector and/or to a motor, constituted by two half-shells being molded in the open position and being closed together about a hinge to form a box-like element adapted to contain and protect individual leads exiting from an unsheathed multicore cable; the half-shells have, at one end, two half-cups provided with elastically flexible tabs adapted to lock the cable, in its unsheathed part, between the half-cups and rigidly with respect to the enclosure, while the opposite ends of the half-shells are preset to connect, upon closure, the stripped leads to the terminals of front-mating connectors of the Faston type or to other motor terminals. The protective enclosure can be provided with engagement elements formed monolithically with the enclosure and adapted to rigidly couple the enclosure to a motor or the like.

### BACKGROUND OF THE INVENTION

The present invention relates to a plastic protective enclosure for preventing damage to connections of individual leads originating from a multicore electric cable or otherwise, to a connector or to an electric motor and, more particularly, to an electric motor which comprises the protective enclosure in at least one of its embodiments.

The problem of connecting a piece of electric cable to another piece of cable, or to an electric motor or to a user appliance, is known.

The cable is usually a multicore cable composed of a sheath which contains two or more leads, each of which is in turn constituted by an insulating sheath which contains a metallic conductor for the electric current.

It is also well-known that in order to provide the electrical connection it is necessary to prepare the cable; this is usually achieved by removing the sheath of the multicore cable for a few centimeters, thus exposing the leads, and by then removing the insulation from the end of the leads for a few millimeters so as to free the metallic conductor.

If the leads are to be connected directly to points of an electric motor or of a user appliance, this connection can be provided in various manners, for example by soldering the exposed metallic conductor to the terminal of the motor or appliance to which current is to be supplied, or, if the motor or the appliance is provided, in a more modern fashion, with metallic current terminals of the Siameze type, manufactured by AMTRONICS, or the like, by inserting and locking with an appropriate conventional tool the metallic conductor in the Siameze terminal.

If the cable is instead to be connected to another section of cable or to an electric motor or other device which already has, for connection to the line, laminar metallic terminals of the Faston type, manufactured by AMP, or the like, the cables and/or wires are usually prepared in the same manner, then metallic terminals of the Faston type or the like are crimped onto the metallic conductors of the wires and, being complementarily shaped, can therefore be mated with the preceding ones; said terminals, when mutually mated, produce the continuity that carries the electric current.

In order to be able to handle them without danger, each one of the metallic terminals crimped onto the wires is usually first inserted in an insulated cap which is shaped internally so as to allow the insertion of the terminal but not its extraction. The caps are then usually all joined at once, forming a so-called terminal block which keeps them parallel and aligned, so that all the terminals of a section mate with the corresponding terminals of the other section or of the motor with a single operation.

However, these procedures do not provide for the protection of the leads, which are loose in the portion between their exit from the multicore cable up to their crimping onto the metallic terminals, i.e., in the portion where the multicore cable has been stripped of its sheath; only rarely are they held together by means of one of the conventional insulating ties which has a tapering toothed end which, after wrapping around the leads, enters the toothed receptacle provided at its other own end and fastens permanently. Moreover, known procedures also do not provide for the coupling of the multicore cable to the terminal block or to the electric motor or other component; accordingly, if the cable is pulled improperly, for example to disconnect the connection or lift the motor, the force is discharged onto the leads and from them onto their crimping to the terminals, with the danger of disengaging the crimping and of consequently interrupting the electrical connection and most of all of having a live metallic end of the lead which can move freely, entailing the danger of accidents.

Various structures have been devised in order to obviate the above-cited drawbacks, i.e., in order to protect the loose leads and anchor the cable; some are very complicated and are constituted by a plurality of metal or plastic pieces which entail various assembly operations, with the result of requiring high production costs due to the amount of material required and to the labor that is necessary. Accordingly, purely for cost-related reasons, loose leads are currently not always protected and multicore cables are not always adequately anchored.

### SUMMARY OF THE INVENTION

The aim of the present invention is to provide a protective enclosure made of insulating plastics for all the connections of wires and/or of a multicore electric cable to a connector, to a motor and to any other user device, which is conceived and structured so as to obviate the drawbacks of current protective enclosures but most of all can be structurally simple, can require limited use of labor and particularly can be obtained entirely by means of a single molding operation, without undercuts or lateral box-like portions, so as to be particularly cheap.

This aim and other objects which will become better apparent hereinafter are achieved by a protective enclosure made of insulating material for protecting the connections of individual leads or of the leads of a multicore electric cable to a connector, to a motor or to another similar electrical device, said protective enclosure being substantially constituted, according to the present invention, by a molded protective enclosure made of insulating plastics which is composed of two wings, of which at least one has raised edges, both wings being hinged on one side so that when they face each other they can contain and protect the above-described unipolar leads and, if said leads originate from a stripped multicore cable, in the portion between their exit from the multicore cable and their crimping onto the metallic terminal, said two wings, substantially two half-shells, comprising at one of their ends two half-cups which, when they face each other, wrap around the multicore cable in the portion that is still provided with its sheath and, by virtue of particular means which are part of said protective enclosure, rigidly anchor said cable to said protective enclosure, further orientating the exit of the cable in the intended direction, preventing the discharge, onto the leads and onto the crimpings of the leads onto the terminals, of any inappropriate traction applied to the cable, said protective enclosure molded from insulating plastics being formed in a single step without undercuts or lateral box-like portions and being shaped so as to assume its final shape by folding and engaging together said two half-shells.

More particularly, for the connection of a multicore cable to laminar contacts, such as Fastons or the like, the two half-shells are hinged directly to one face of a prism-shaped terminal block which contains said front-mating Faston contacts, so as to constitute, after the closure of said half-shells, a single insulating body which is capable of ensuring both the anchoring of the cable and the protection of the leads arranged inside the half-shells and of the front-mating Faston contacts contained in the box.

The multicore cable is locked to the end of said half-shells by using at least one toothed tab which is preferably formed monolithically with the protective enclosure and can be inserted in a recess or cavity which is also internally toothed.

### BRIEF DESCRIPTION OF THE DRAWINGS

Further characteristics and advantages of the present invention will become better apparent from the following detailed description, given with reference to the accompanying drawings, which are provided only by way of non-limitative example and wherein:

FIG. 1 is a perspective view of a protective enclosure provided according to a first embodiment of the present invention, applied to a terminal block for three connectors for female Faston metallic terminals for laminar terminals, and shown with one wing or half-shell open, in the condition in which it is obtained in the molding process, and with the other wing or half-shell closed at 90°;

FIG. 2 is a view of the same terminal block provided with the protective enclosure according to the present invention, ready to be coupled and internally containing the metallic terminals, of which only the tips are visible, the leads, which are not visible because they are enclosed between the two half-shells closed at 90°, and the cable, which is visible at its exit;

FIGS. 3 and 4 are two plan views of the protective enclosure of the preceding figures, applied to a terminal block, as it appears after molding;

FIG. 5 is a sectional view of FIG. 3, taken along the plane V-V, in which all the holes are at 90° to the plane of the wings and therefore can be provided without undercuts;

FIG. 6 is a sectional view of the protective enclosure and of the terminal block in the assembled condition of FIG. 2, taken along the plane VI-VI of said figure, in the position in which they face the corresponding male Faston terminals of another connector (or motor or other) to which the connector can be mated;

FIG. 7 is a view of the detail of the crimping of the cable, according to a particularity of the present invention;

FIG. 8 is a view of a motor which uses the protective enclosure of FIG. 2 to supply current, since according to the invention one of its internal elements is appropriately modified and has laminar terminals which are adapted to be coupled therein.

### DESCRIPTION OF THE PREFERRED EMBODIMENTS

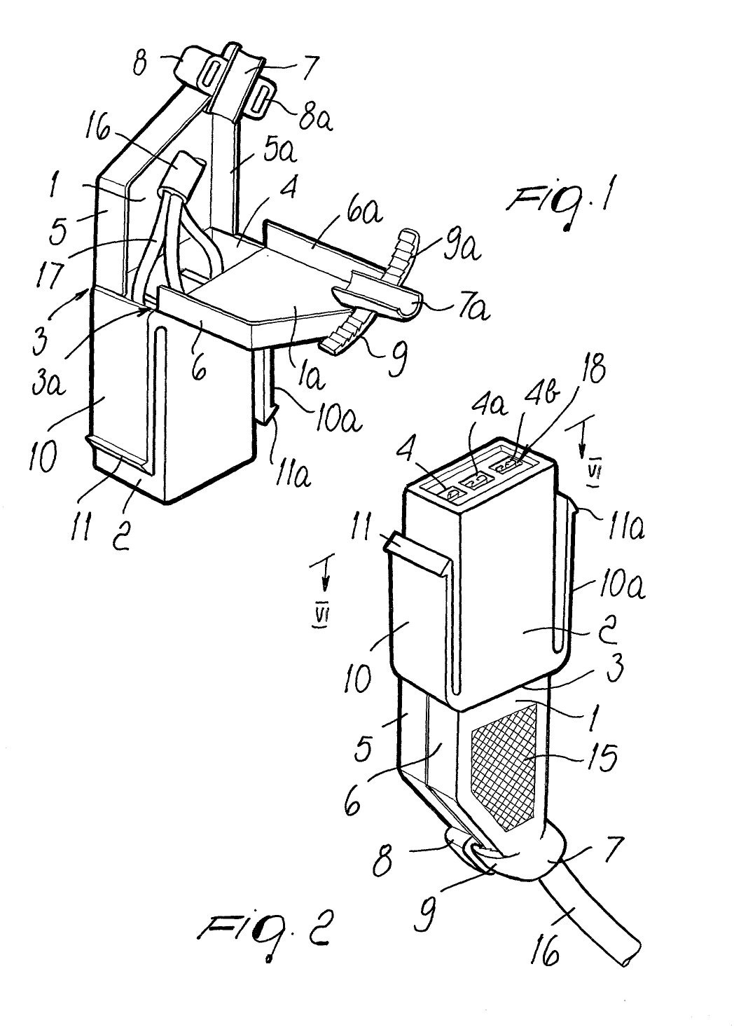

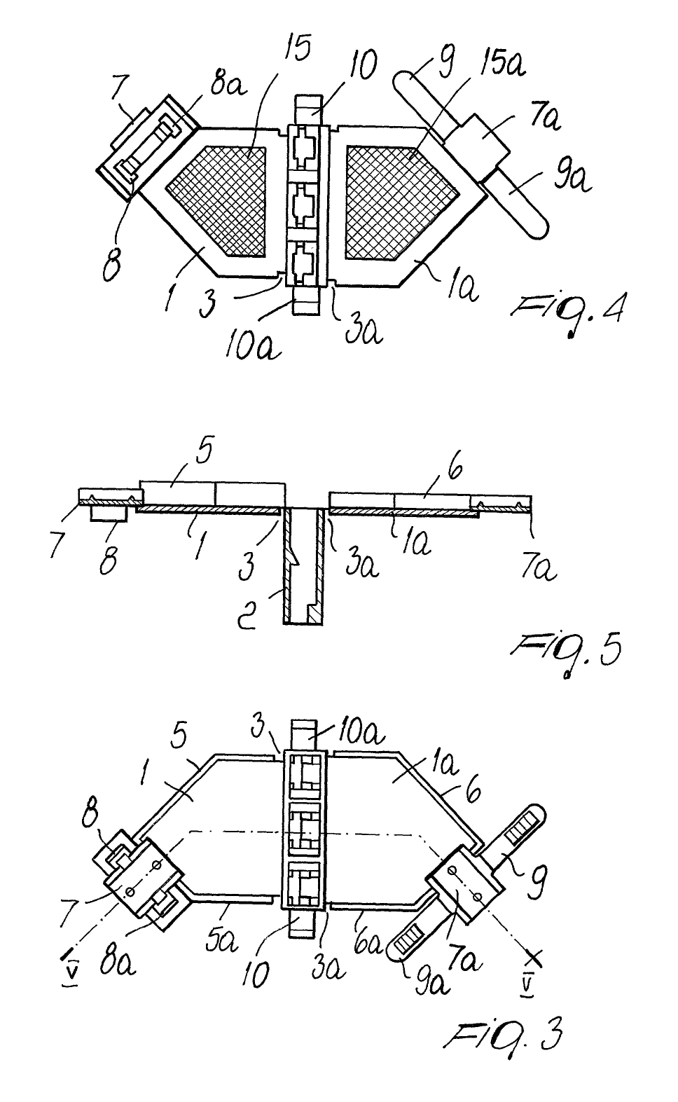

With reference to FIGS. 1 to 7, the protective enclosure according to the present invention is constituted by two half-shells or wings 1 and 1a, which are substantially mirror-symmetrical and are made of insulating plastic material monolithically with a parallelepipedal element 2, which constitutes the terminal block of a connector, and to which they are connected by means of hinges 3-3a (FIG. 1) arranged on two edges of an end face of the parallelepiped 2.

More particularly, three through cavities 4, 4a, 4b are formed inside the parallelepipedal body 2; each cavity constitutes the seat for stably accommodating and retaining one of the chosen terminals 18, which are shown, by way of example, as being of the female Faston type in FIG. 2 and in FIG. 6.

Each half-shell 1-1a has two opposite raised edges 5-5a and 6-6a which lie at approximately 90° with respect to the plane of the corresponding half-shell; their width is such that when the half-shells face each other the pairs of edges 5-6 and 5a-6a mate and/or overlap, thus forming a box-like element which contains and protects the leads 17 freed from the cable 16 (FIGS. 1 and 6). At the opposite ends of the wings or half-shells 1 and 1a there are two half-cups which are formed monolithically with said wings, are designated by the reference numerals 7 and 7a respectively, and wrap around the cable 16 when the half-shells face each other (FIGS. 1, 2, 3, 4, 5, 6, and 7).

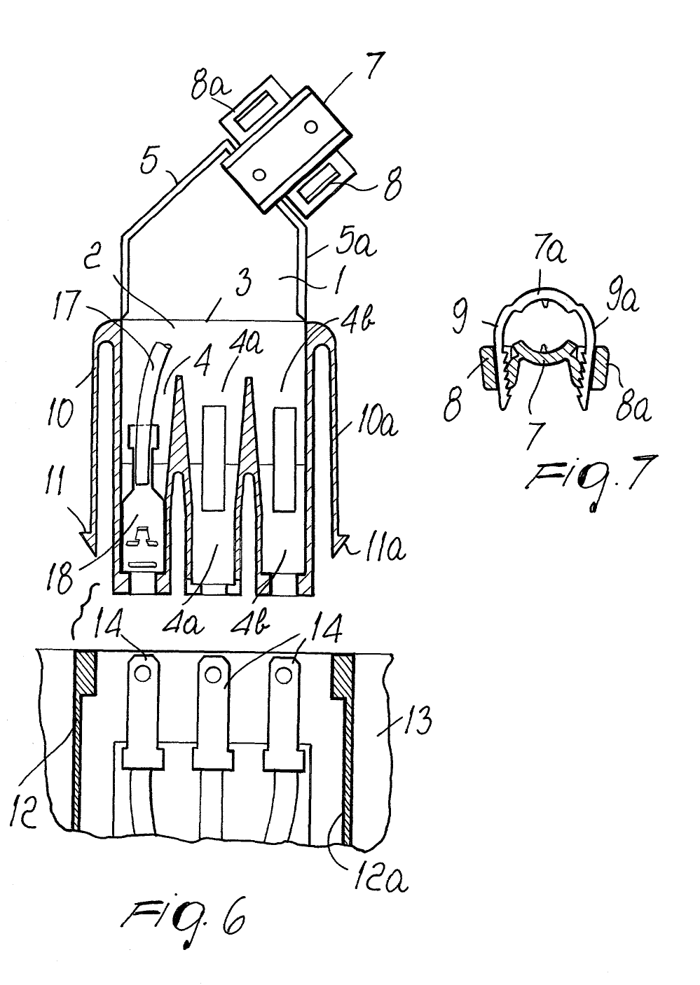

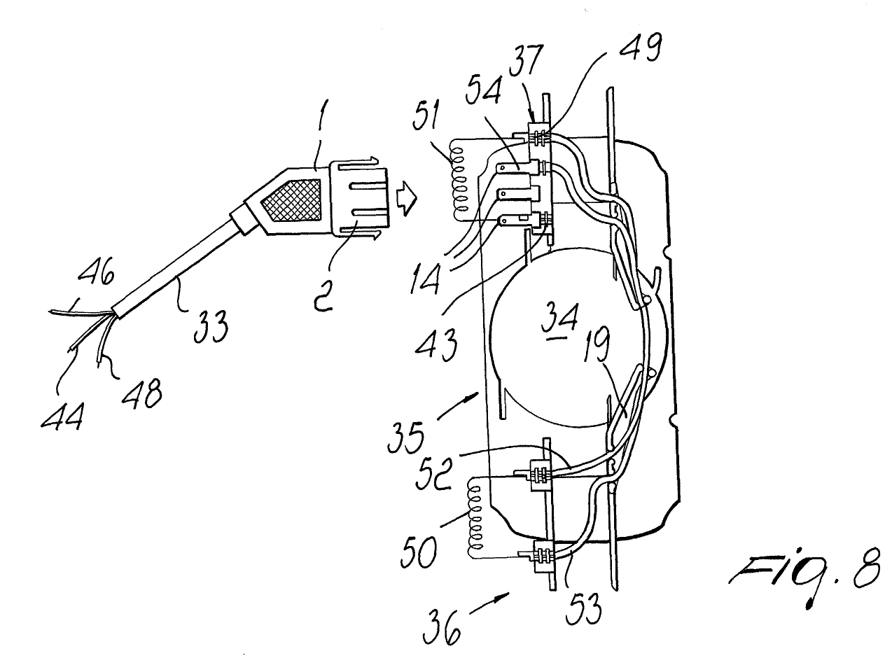

Two internally toothed recesses 8-8a are formed on the edges of the half-cup 7 in order to receive and lock the ends of two toothed straps 9-9a; said two elastically deformable toothed straps 9 and 9a are in fact formed on the edges of the half-cup 7a so as to protrude from the opposite sides of the half-cup, and when the half-shells face each other said straps enter the recesses 8-8a (FIG. 7).

FIG. 6 illustrates the three separate insulating caps 4, 4a and 4b which are adapted to protect the terminals 18 and are joined at the base in a single structure 2 to which the two wings 1 and 1a are connected.

The protective enclosure thus conceived can be provided with means adapted to ensure engagement to the element 13 to which it is to be connected, by providing on two opposite sides of the terminal block 2 two tabs 10 and 10a which yield elastically and are provided, at their ends, with teeth 11 and 11a which are meant to engage corresponding elements 12 and 12a of the element 13 to be connected, which is provided with the male Faston laminar terminals 14, as shown in FIG. 6.

In order to allow easier handling of the assembly, the outer surfaces of the two wings 1-1a can be made rougher by means of knurled regions 15-15a.

In FIGS. 1-2-6, the cable, which is shown as being of the three-pole type by way of example, is designated by the reference numeral 16 as regards its unsheathed part; the insulated leads are designated by the reference numeral 17, and the terminals crimped onto the unsheathed part of the leads are female Faston terminals designated by the reference numeral 18.

The protective enclosure can also be used to protect other live parts of the motor by placing them inside the chamber formed by its two wings or by shielding them with just one of the wings.

The operator must first of all take the multicore cable, remove its sheath for a few centimeters, thus freeing the individual insulated leads, and then strip said leads for a few millimeters, exposing the internal metallic wire. He must crimp terminals of the Faston type or the like onto said wire, and then insert the Faston terminals in the cavity 4-4a et cetera of the parallelepipedal element 2 and arrange the leads in the half-shell 1. The operator then folds the two wings 1 and 1a toward each other through 90° or 180° until they mate, thus enclosing in the space between them the insulated leads that protrude from the terminals to which they have been coupled.

While the operator is folding the half-shells, he arranges the sheathed part of the cable between the appropriately provided half-cups 7-7a (FIG. 1) formed at the end of the half-shells, which thus face each other. By inserting the two straps or tabs 9 and 9a of the half-cup 7 in the corresponding recesses 8 and 8a and firmly pressing the two half-couples together, so as to make the teeth of the tabs snap-lock on the teeth in the recesses, he locks the cable between the two half-cups and simultaneously closes the box-like element composed of the two wings.

The two facing half-cups can also be clamped together by a toothed tab which is external to the protective enclosure or by virtue of another conventional means without thereby abandoning the scope of the invention.

The particularity of the invention, as mentioned, is that the protective enclosure is provided integrally by means of a single molding operation; this is allowed by the fact that it can be molded with the opposite wings 1-1a so set apart at 180° to each other and at 90° to the extraction axes of all the intended holes or seats, without undercuts and without lateral box-like portions, with evident practical and economic advantages.

FIG. 8 illustrates the application of the protective enclosure to an electric motor and the particular improvements to some of its structural elements.

The reference numeral 34 designates the bore in which the rotor, not shown herein, turns; the reference numeral 35 designates the stator (which is the subject of another patent and is not described herein); the reference numeral 36 designates a spool which supports a field winding 50, which is shown only schematically herein, and a pocket 39 for containing the motor cutout, if provided, and the reference numeral 37 designates the other spool which supports at 180° the other winding 51, which is shown only schematically herein and is modified for connection to the protective enclosure of FIG. 2.

The electric motor shown in FIG. 8 has, in order to receive current, known SIAMEZE terminals which end with laminar contacts of the Faston type 14. In this case, current is supplied to the motor by mating said laminar contacts 14 with the female Faston contacts 18 that are contained in a protective enclosure according to FIGS. 1 and 2; two of said contacts are connected to the leads 48 and 46 and carry the current, while the third contact 44 is connected to the ground lead. The leads 52 and 53 of the ends of the winding 50 of the spool 36 are placed in the structure 19, which protects them against vibrations and friction against the rotor and other grounded parts of the motor, and are transferred onto the spool 37, where they are mated with the SIAMEZE terminals 49 and 54. The terminals of the winding 51 are mated with the SIAMEZE terminals 43 and 49. The wires 52 and 53 can be replaced with portions of lead, as shown in the figure, if mass-production of the windings of the two spools requires the anchoring of the ends of the windings to the respective spools for technical reasons.

The motor according to the present invention, connected as shown in FIG. 8 and freed from the constraint of the cord or cable (which each customer requires in the length that best suits him), considerably reduces the inventory required to meet customer requirements.

The invention can provide other embodiments. The power supply may have for example six or seven leads if the motor is of the three-phase type. The terminals can be of a more modern or less modern type, may have different shapes and dimensions, and may be arranged in more than one row. The structures may have different shapes in order to adapt to user devices which are not considered herein.

All this is provided without abandoning the protective scope of the appended claims.

The disclosures in Italian Patent Application No. MI2000A000274 from which this application claims priority are incorporated herein by reference.

What is claimed is:

1. A protective enclosure for connections of a multicore electric sheathed cable accommodating stripped unipolar leads that protrude from an end of said cable and lock said cable at a sheathed part, the enclosure comprising: two half-shells, at least one of which having raised edges formed by molding insulated plastic material; hinge means constituted by straight plastic strips provided at said half-shells so as to allow said edges to mate, by rotating said half-shells toward each other, wherein to constitute a closed box for containing and protecting said unipolar leads; two half-cups provided one at an end of each one of said half-shells, said half-cups being movable so as to face each other and bear against said cable at said sheathed part to mate with each other after rotation of said half-shells toward each other; anchoring means for providing a stable anchoring of the cable between said half-cups, said anchoring means being constituted by at least one toothed tab which is rigidly coupled to a first one of said half-cups and by corresponding toothed openings which are rigidly coupled to a second one of said half-cups, said half-shells, said tabs and said corresponding openings being all formed through a single molding operation for molding insulating plastic material with said two half-shells spaced apart at 180° to each other and at 90° to extraction directions of said leads from the enclosure.

2. The protective enclosure of claim 1, comprising a box-like body including a seat for laminar metallic terminals of the Faston type, said hinges being provided on two opposite sites of a front face of said box-like body, so that upon closure of said half-shells the insulating protective enclosure is configured so as to be rigidly coupleable to an electrical connector of a front-mating type, and so as to accommodate, in addition to metallic terminals of the connector, the unipolar leads protected by said half-shells and so as to provide, by way of said two half-cups, anchoring of the cable to said protective enclosure, said box-like body containing the metallic terminals and said protective enclosure being formed monolithically through a single molding operation in which all of the lead extraction directions are parallel.

3. In combination with an electric motor of the type in which a winding thereof is distributed on two spools which are arranged at 180° to each other with respect to a rotor axis, the motor having at least two metallic terminals rigidly coupled to one of said spools to which ends of the winding are connected, a protective enclosure as set forth in claim 2, which comprises metallic terminals of a type which mates with said terminals of the motor.
